(19) United States
(12) Patent Application Publication
(10) Pub. No.: US 2016/0023374 A1
(43) Pub. Date: Jan. 28, 2016

(54) RIGID COMPOSITE STRUCTURE FOR MAGNETIC COUPLER

(71) Applicant: THEODORE L KEGERIS, Fairland, IN (US)

(72) Inventor: THEODORE L KEGERIS, Fairland, IN (US)

(21) Appl. No.: 14/807,318

(22) Filed: Jul. 23, 2015

Related U.S. Application Data
(60) Provisional application No. 62/027,954, filed on Jul. 23, 2014.

(51) Int. Cl. B28B 7/00; B28B 7/06

(52) U.S. Cl. CPC B28B 7/002; B28B 7/0085; B28B 7/06

(57) ABSTRACT

A composite member is provided for use with a mold for creating a feature in a product formed in the mold. The composite member includes a bend resistant first stiffener member and at least a first and a second magnet member. The first and second magnet member are configured for forming a magnetic current for magnetically coupling the composite member to the mold. The composite member also includes a composite body portion configured for substantially encasing the stiffener member and the first and second magnet member. The composite body portion includes a product engaging surface configured and positioned for defining a surface of the product formed in the mold.

### RELATED APPLICATIONS

This U.S. Non-provisional patent application claims the benefit of and/or priority to Kegeris, U.S. provisional patent application Ser. No. 62/027,954 filed 23 Jul. 2014, the entire contents of which is specifically incorporated herein by reference.

### TECHNICAL FIELD OF THE INVENTION

The present invention relates to construction devices and more particularly to a device used in the manufacture of concrete items, such as pre-cast concrete items.

### BACKGROUND OF THE INVENTION

Concrete is an ancient building material that has been used for centuries to construct a variety of structures including buildings, roads, sidewalks, parking garages, walls, basements, and surprisingly even boats.

The four primary ingredients of concrete include water, Portland cement, aggregates and admixtures. The four ingredients are mixed together and placed in a flowable form. The flowable concrete is then given its final shape by pouring it into a “form” that serves the same primary purpose as a mold, insofar as the final “product” has a shape that mimics the shape of the form.

To create a concrete structure such as a road, the area in which the road is to be constructed in a depth appropriate for the particular type of road bed being created. After the road bed is excavated, it is filled with a drainable underlayment such as gravel, sand or the like so that water that collects under the road will drain downwardly, and not collect in pockets under the concrete slab that could ultimately undermine the integrity of the concrete slab being poured.

A form is then usually created that is placed on top of the drainable underlayment. After the form is in place, the flowable concrete is then poured into the form and allowed to cure and harden into the final product.

Typically, forms can be as simple as a rectangular box that is formed to have the proper dimensions out of materials such as 2″×12″ boards. Alternately,the form can comprise a tall steel walled member when one is pouring a concrete wall, such as a basement wall. As the concrete form serves the same basic purpose as a mold, it will be appreciated that the size and shape of the form will be governed largely by the size and shape of the end product structure being created.

Although most concrete structures are formed in-situ, in the place where they will ultimately reside, a large number of concrete structures are formed in “pre-cast” concrete products, at a place remote from the final resting spot of the product.

The same process performing concrete structures in situ is generally employed in the creation of a pre-cast concrete structure. However, pre-cast concrete structures are typically formed in metal forms that are capable of being re-used quite often to create a variety of concrete structures. Metal forms are usually employed because they have superior release capabilities, and durability and precious capabilities when compared to traditional wooden forms.

Pre-cast concrete molds or forms are currently available from a variety of sources in an infinite variety of shapes and sizes. Examples of companies that supply pre-cast concrete molds include Norwalk Pre-Cast Molds or Norwalk, Ohio. (www.norwalkprecastmolds.com); Verti-Crete Pre-Cast Products of Bluffdale, Utah, 84065 (www.verti-crete.com); Del Votto Products of Wrenshall, Minn. (www.delvottoprecastforms.com) and others, that are can be found through the use of any Internet search engine.

Pre-cast concrete forms, and the concrete structures created thereby differ from concrete structures created in situ, as pre-concrete structures must normally be designed so that they can be transported from the factory at which they are cast, to the structure which they are installed.

In production, a pre-cast concrete mold or form is usually formed of steel that is placed onto a steel floor or stage surface. Concrete is then poured into the form on the floor to an appropriate depth and allowed to harden. After the hardening of the concrete occurs, the pre-cast concrete structure is removed from the form and shipped to the place where it is to be installed.

When preparing such pre-cast structures, it is often desirable to have an edge that is chamfered, rather than having a corner where two planes meet at a 90 degree angle. In order to create such a chamfered edge, a chamfer member is placed into the form and serves as a “mold insert”. To form a chamfered corner, the chamfer member is usually placed in a position where two planes intersect. A chamfer member generally has a right triangular cross section and a length that extends for a certain distance depending upon the size of the concrete structure being created and a length of the chamfered corner that is desired.

A pre-cast concrete product production facility will typically include chamfers having a variety of sizes, such as 6′, 8′, 10′, 12′ or longer length chamfer members to accommodate various projects.

In addition to chamfer members, it is often desirable to mold other “features” into a pre-cast concrete structure. These other features can include such things as cavities that enable one to have a place to grip the pre-cast structure when moving it. Other features that designers often desire to have incorporated into a concrete structure include aesthetic features such as scripts and scroll work, and letters and numerals to provide addresses, or some other identifying indicia.

Further, features are often formed into the concrete for the purpose of adding a component to the concrete structure. For example, a pair of mold inserts might be used that are capable of gripping a pipe and being inserted into the interior of the pipe. The mold inserts can be positioned in the form to grip the pipe with the flowable concrete being poured around the pipe. In such a situation, the final concrete structure will include a pipe that extends there through, that has both ends “open” because of the manner in which the insert gripped the pipe. One can then use the pipe for conveying a liquid such as water or sewage or otherwise passing electrical conduit, or some other material through the concrete structure.

As the particular features that one would desire to incorporate into a concrete structure can likely vary significantly from project to project, the most common method for creating such features is through the employment of a mold insert member that can be selectively coupled and removed from the mold member, as opposed to being a permanent part of the mold member.

For the sake of identification, as opposed to limitation, these various structures that one might use in connection with the concrete form or mold will be referred to herein as “mold inserts” or “form inserts”, as they are inserted into a mold or form in which a concrete structure is created to create a feature (be it aesthetic or functional) that becomes incorporated into the concrete structure that is being cast in the mold.

Mold inserts are not new. Initially, most inserts were made from a steel material that was coupled to one of the surfaces of the actual concrete form or mold. Steel members were used because they were believed to work well with the steel forms, and the steel floors on which the forms for the pre-cast concrete structures were formed.

Although steel inserts work well, they have certain disadvantages. One disadvantage of the use of the steel form is that the steel in the insert can rust. Another disadvantage of using a steel insert member is that it does not release well from the concrete, after the concrete is poured into the form and structure and allowed to harden into the end product structure. As such, when the form and insert member are removed from the pre-cast concrete member, the steel chamfer will stick to the concrete. In such a case, extra labor is required to separate the steel insert from the concrete structure that was created. During this separation, the surface of the concrete structure may become marred because chunks of concrete might be adhered to the steel chamfer and thereby form away from the formed structure.

To overcome such deficiencies, the Applicant invented a flexible composite structure that included a magnet for magnetically coupling the insert to a steel component of the steel form. The flexible composite structure is shown in Kegeris, U.S. Published Patent Application No. 2013/016481 that has a publication date of 27 Jun. 2013 and the disclosure of which is incorporated herein fully.

The Kegeris flexible composite magnetic structure shown in the ′481 published patent application has found great utility within the industry. As is described in more detail in the ′481 application, the Kegeris ′481 published patent application discloses a urethane member into which magnet strips and fiber glass patches are embedded. The fiber glass patches provide structural integrity and flexibility that permit the insert member to be bent, twisted and otherwise retain significant amount of flexibility. As the magnetic members are provided in small segments that often comprise a length that is generally only a small fraction of the total length of the insert, the magnetic members do not significantly impede the ability of the flexible insert to be bent.

One of the benefits that the Applicant sought to achieve in this flexible insert was to achieve a composite structure that had flexibility, as flexibility allows the insert to better adhere to uneven shapes while also making the flexible structure easier to apply and remove from the steel concrete form.

Although the device shown in the Kegeris ′481 patent application represents a great advance over the prior art, room for improvement still exists. In particular, it has been found by the Applicant that surprisingly, some applications are better served by the use of a stiffer, more rigid steel insert member. It is therefore one object of the present invention to provide a polymeric mold insert member that includes a stiffener that creates a mold insert that includes the desirable release characteristics of a polymeric insert, with the structural stiffness characteristics that are desirable in many circumstances.

### SUMMARY OF THE INVENTION

In accordance with the present invention a composite member is provided for use with a mold for creating a feature in a product formed in the mold. The composite member includes a bend-resistant first stiffener member and at least a first and second magnet member. The first and second magnet members are configured for forming a magnetic current for magnetically coupling the composite member to the mold. A composite body portion is configured for substantially encasing the stiffener member and the first and second magnet members. The composite body portion includes a product engaging surface configured and positioned for defining a surface of the product formed in the mold.

Preferably, the mold comprises a concrete form and the product formed in the mold comprises a pre-cast concrete structure. The stiffener member can comprise a metal plate having a series of apertures that extent through the metal plate, and through which the composite member can pass for this interlocking the stiffener member with the composite body portion.

In a most preferred embodiment, a second stiffener member is provided that is placed in a parallel plane with the first stiffener member, and placed in a spaced relation to the first stiffener member. The first and second magnet members are disposed between the first and second stiffener members, and coupled to each of the first and second stiffener members.

Additionally, a third stiffener member can be provided that is disposed in a parallel plane with each of the first and second stiffener members, and is placed in a spaced relation to the second stiffener member. A third and fourth magnet can be disposed in the space between the second and third stiffener members, and coupled to each of the second and third members.

One feature of the present invention is that the use of the stiffener/magnet assembly is in conjunction with the composite body provides a mold insert that is relatively rigid. This feature has the advantage of providing a mold insert that has good product release features because of the composite body, while maintaining a desirable rigidity.

These and other features of the present invention will become apparent to those skilled in the art upon a review of the drawings and detailed description presented below.

### DESCRIPTION OF THE DRAWINGS

FIG. 1 is a perspective view of a right triangular chamfer type mold insert of the present invention;

FIG. 1A is a partially sectional view of a mold insert of the present invention coupled to a mold;

FIG. 2 is a side view of the right triangular chamfer type mold insert shown in FIG. 1;

FIG. 3 is a sectional view of a mold in which the chamfer member of FIG. 1 can be formed;

FIG. 4 is a perspective view of a stiffener/magnet assembly of the present invention;

FIG. 5 is a top view of the stiffener/magnet assembly of the present invention;

FIG. 6 is a side view of the stiffener/magnet assembly of the present invention;

FIG. 7 is another perspective view of a right triangular mold insert member constructed according to the present invention;

FIG. 8 is a sectional view taken along lines 8-8 of FIG. 7;

FIG. 9 is a sectional view taken along lines 9-9 of FIG. 8;

FIG. 10 is a top view of a first alternate embodiment old insert member of the present invention;

FIG. 11 is a sectional view taken along lines 11-11 of FIG. 10;

FIG. 12 is a sectional view of a concrete form or mold including a first and second mold insert member of the present invention attached thereto;

FIG. 13 is a top view of a second alternate embodiment mold insert member;

FIG. 14 is a sectional view taken along line 14-14 of FIG. 13, to which a bolt-type puller is shown in an exploded view;

FIG. 15 is a bottom view of the second alternate embodiment mold member of FIG. 13;

FIG. 16 is a top view of a third alternate embodiment mold insert of the present invention;

FIG. 17 is a side view of the third alternate embodiment mold insert member of FIG. 16;

FIG. 18 is a bottom view of the third alternate embodiment mold insert member shown in FIG. 17;

FIG. 19 is a bottom view of a metal skeleton to which a polymer may be added to create a fourth alternate embodiment mold insert of the present invention;

FIG. 20 is a side view of the steel skeleton of FIG. 19; and

FIG. 21 is a sectional view taken along lines 21-21 of FIG. 20,

### DETAILED DESCRIPTION

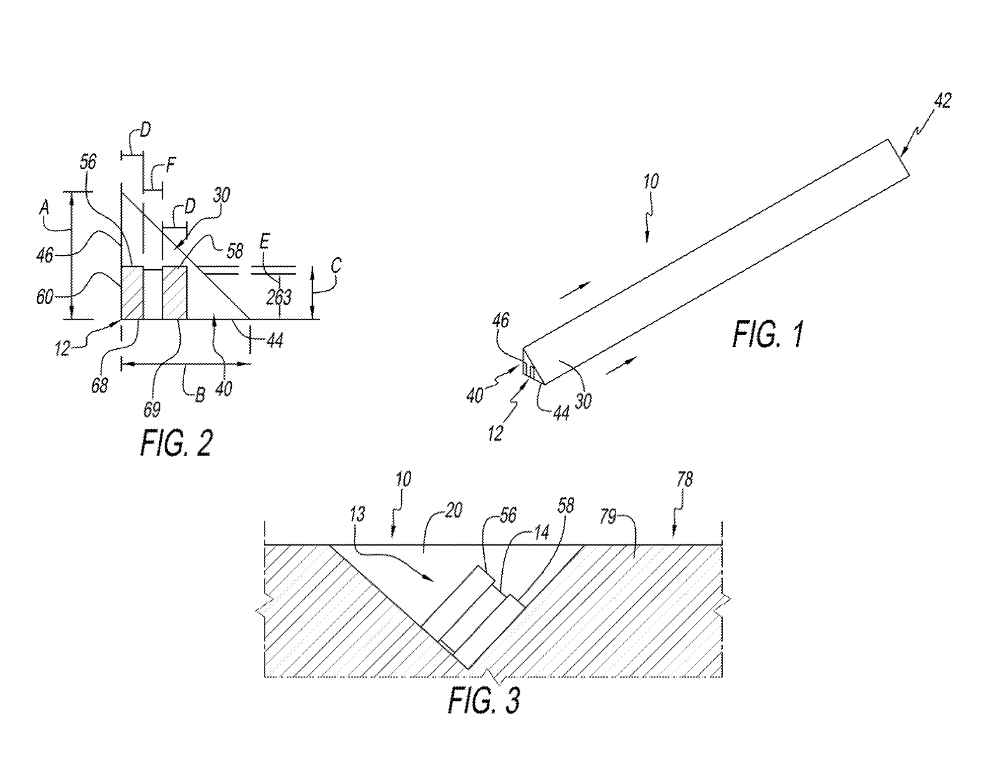

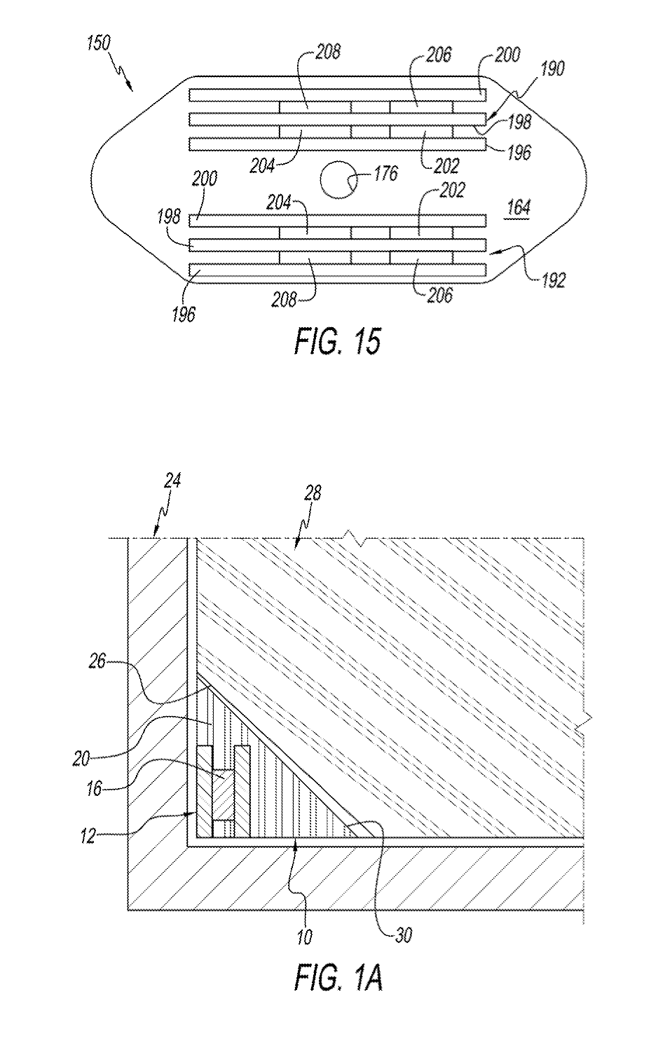

A composite member that comprises a mold insert 10 is shown in the FIG. 2. The mold insert 10 includes a bend resistant stiffener member 12 that preferably comprises one or more elongated plate-like steel strips. The mold insert also includes a first and second magnet member 14, 16 that are provided for magnetically coupling the mold insert 10 to a mold 24 (FIG. 1A). Mold 24 is preferably a mold of the type that is used to create a product 28, such as a pre-cast concrete structure. The mold insert 10 is provided for forming a feature 26 in the product 28 that is formed by the mold, and includes a product engaging surface 30 that engages a surface of the product 28 that is being molded to form the feature 26.

The composite member also includes a composite body 20. The composite body 20 is preferably comprised of a non-magnetic, plastic material, such as urethane, rubber or the like.

The mold insert 10 that is shown in FIG. 1 comprises a chamfer type mold insert, of the type that is used to form a chamfered corner on a molded product, such as a concrete structure.

The chamfered surface of the finished concrete product might also be considered to be a bevel that connects two planes such as the upper surface and side surface of the product being molded at a 45 degree angle, rather than the 90 degree angle that one would normally connect to perpendicular planes of a structure such as a pre-cast concrete structure. The chamfer mold insert member 110 comprises an elongated right triangular member that has a first planar mold engaging surface 44, a planar second mold engaging surface 46 and a product engaging surface 30 that extends between the first and second mold engaging surfaces 44, 46.

The first and second mold engaging surfaces 44, 46 meet at a right angle, and the product engaging surface 30 serves as the hypotenuse of the triangle to join the first and second mold engaging surfaces 44, 46.

Turning now to FIG. 2, some dimensions are given for a particularly favorable and preferred embodiment of mold insert 10. Although it will be recognized that the shape and dimensions of any particular insert 10 will vary widely depending upon the feature being made and the size of the product being made, the dimensions shown in FIG. 2 represent typical dimensions that one might use for a chamfer type mold insert 10 of the type shown in FIG. 1.

It will also be appreciated that the size and shape will also largely be governed by the particular nature of the feature that one wants to form into the final product being molded. For example, if the pre-concrete structure being molded were a ramp section of a sidewalk, the insert 10 could be quite large, and have a “negative” ramp like appearance, so that the final molded product would have “positive” ramp-like configuration,

Turning to FIG. 2, the various dimensions are that the height B and width B of the mold insert are each at 0.75 inches. This represents the size of the two mold engaging surfaces 44, 46. The hypotenuse product engaging surface 30 has a width dimension of 1.061 inches, which of course equals the square root of 2, times the width of the two mold engaging surfaces 44, 46.

The height of the stiffener member 12C is approximately 0.312 inches, and the width D of the stiffener member 12 is approximately 0.125 inches. The magnet 14 is disposed between the two stiffener bar members 56, 58 and is coupled to both the stiffener members 56, 58. The magnet is slightly smaller in height than the stiffener members 12, having a height E of 0.265 inches, and also includes a slightly thinner, and has a thickness F of approximately 0.110 inches.

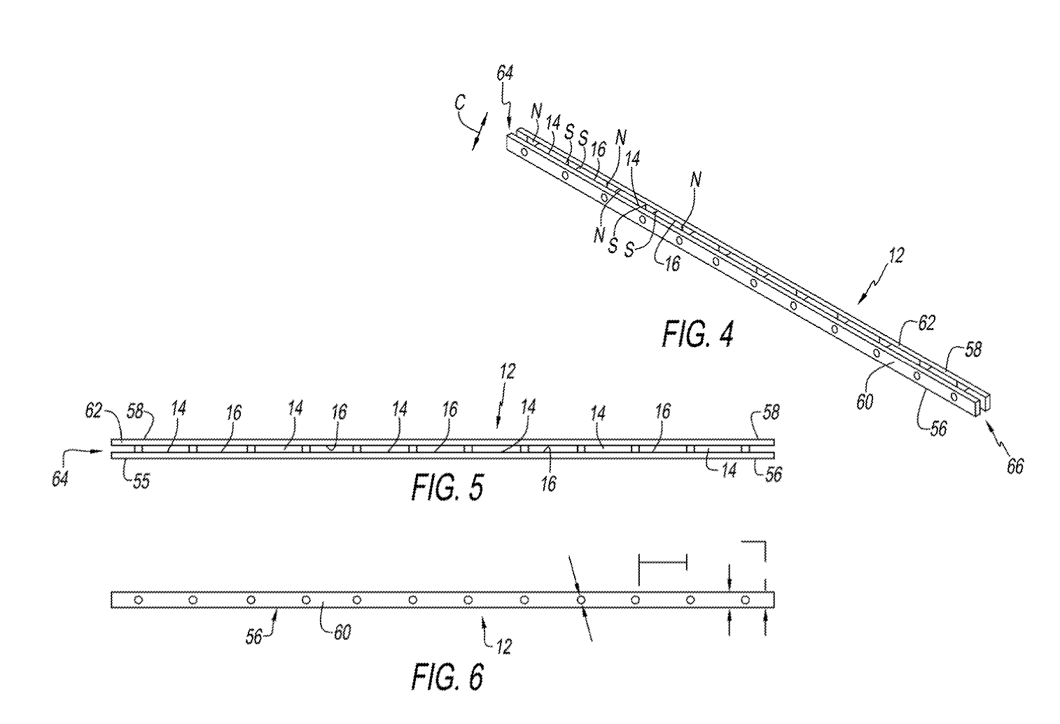

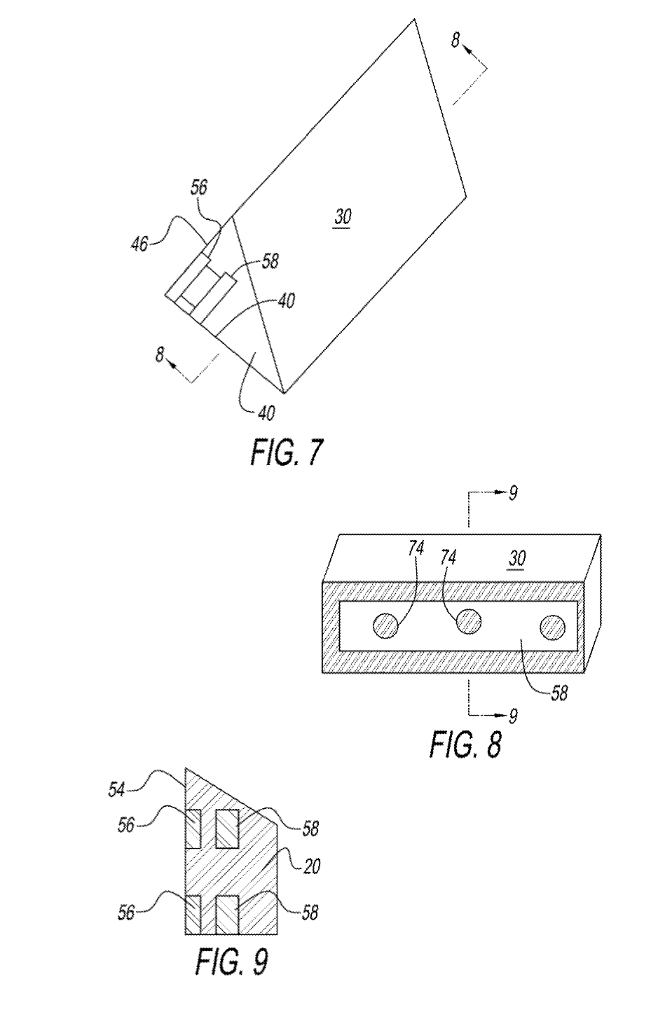

The stiffener/magnet assembly 13 is well shown in FIGS. 4-6. The stiffener member 12 includes a first and second stiffener bar 56, 58. The first and second stiffener bars 56, 58 preferably comprise steel bars that are stick or ribbon-shaped and somewhat elongated. Preferably, the stiffener bars 56, 58 have a generally rectangular cross section, and a length that is substantially greater than their width, often by a factor of five or ten.

The length generally will vary depending upon the length of the mold insert 10 that is to be created. In most cases, the length of the stiffener bars 56, 58 should be slightly smaller than the length of the mold insert in which the stiffener bar is encased, so that the composite material, such as urethane or rubber can fully encase the stiffener member 12 within the polyurethane.

As shown in FIG. 2, the stiffener member is preferably positioned so that a side edge 60 of the stiffener member is generally placed adjacent to the mold engaging side surface 46. In this regard, the first stiffener member 56 can be positioned within the mold insert so that the side surface 60 is exposed and is generally disposed in a co-planar relationship with the mold engaging surface 56 of the insert. Alternately (as shown in FIG. 3), the first stiffener bar 56 can be slightly recessed inwardly from the mold engaging surface 56 so that a thin layer of urethane or other composite covers the side surface 60 of the first stiffener member 56.

The Applicants have found that it is helpful to play the stiffener member 60 (and hence magnet 14) close to the mold engaging side surface 46, so as to enhance the magnetic interaction between the magnet 14 and the mold 24 in which the molded product is being formed to enhance the magnetic bond between the insert and the mold.

It will also be noted that the bottom edge surfaces 68, 70 of the stiffener members is placed adjacent to the first mold engaging surface 44. Once again, this is done to place the magnet 14 in as close proximity as possible to the steel mold 24 in which the product is being formed.

It will be noted that the proximity of each of the bottom edges 68, 69 and side surface 60 of the stiffener member to the mold engaging surfaces 44, 46 is significantly less than the distance between the stiffening members and the hypotenuse surface 30. As the hypotenuse shaped product engaging surface 30, engages a non-magnetic, concrete product being formed, there is no need for enhancing the magnetic interaction between the stiffener member 12 magnet assemblies 14 and the product being formed in the mold.

The first and second stiffener bars 56, 58 are preferably identical, and made out of a steel material. Although they can be bent through the application of a large enough force, they are generally rigid and bend resistant to bending because they are formed of a metal or other steel material. As such, as directly opposed to the flexible fiberglass members disclosed in the 40 041 Kegeris patent application, the stiffening members 56, 58 are generally rigid, and unlikely to bend except under the influence of a strong mechanical force of a type usually greater than one might be able to exert solely with one's hand, and without some device to obtain a mechanical advantage.

Each of the stiffening bars 56, 58 includes a plurality of spaced perforations. The spaced apertures or perforations 74 extend between the first major outer side surface 60 and the inner side surface of each of the stiffener bars 56, 58. The apertures 74 pass completely there through. In the final product, the composite material from which the composite body 20 is made flows through the apertures 74 and hardens within the apertures 74 and the interior spaces between the first and second stiffener members 56, 58 that are not occupied by the first and second magnet members 14, 16. By occupying these spaces and extending through the perforations 74, the composite material interlocks the stiffener/magnet assembly into the composite body 20, to help maintain the composite body 20 and stiffener member 12 magnet 16 assembly as an integral unit.

As will be appreciated, the magnetic interaction between the magnet 14, 16 and the steel of the mold 24 in which the product 28 is being formed, would tend to exert a force against the composite member, such that the stiffener/magnet assembly 13 would tend to want to continue to adhere to the steel walls of the mold member 24, when one tried to remove the composite body 20. Through the interlocking that is facilitated by the composite passing through the perforations 74, the stiffener/magnet assembly 13 and composite body 20, should be sufficiently well adhered and joined to each other, so that pulling on the composite body 20 to remove the composite member 10 from the mold will cause the stiffener member assembly 12, 14, and composite body 20 to come off as a single unit, so that the mold insert 10 may be used again.

As shown in FIGS. 4, 5, and 6, the stiffening members 56, 58 are disposed elongated, ribbon like plate shaped members and are disposed in a parallel plane with each other. The first and second stiffening member 56, 58 are disposed in a spaced relationship to create a space between the first and second stiffening members 56, 58. The magnet members 14, 16 are disposed in this space between the first and second stiffening members 56, 58 and are coupled there between so as to form something of a sandwich. Although the magnets 14, 16 can be helped in by a frictional engagement, they may also be coupled to the steel stiffening members through magnetic attraction, or the use of an adhesive or screw member.

As the stiffening members 56, 58 are preferably made of steel, the magnetic attraction between the relatively strong, permanent rare earth magnets 12, 14 and the steel stiffener members 56, 58 should do a fairly good job of maintaining the integrity of the stiffener/magnet assembly 13.

As best shown in FIGS. 4 and 5, a plurality of magnets are disposed between the first and second stiffening members 56, 58. The magnets include a plurality of first magnets 14 and a plurality of second magnets 16. To enhance the magnetic circuit, the magnets are oriented so that the first magnet 14 is oriented in a North-South pole orientation, whereas the adjacent, second magnet 16 is oriented in a South-North orientation. This North-South/South-North orientation scheme is carried through with the remainder of the first and second magnets 14, 16 of the magnet stiffener/magnet assembly 13.

Turning now to FIG. 3, a mold assembly 78 in which the mold insert 10 can be formed is shown. The mold assembly 78 comprises a traditional mold that is typically made out of a steel material. The mold 78 includes a planar upper surface and a trough formed therein that comprises the mold's cavity. The trough is generally V-shaped, and includes a right angled bottom point, that corresponds generally to the right angle that is formed between the first and second 44, 46 planar mold engaging surfaces of the finished insert 10.

In order to create the insert 10 stiffener/magnet assembly 13 is appropriately positioned within the trough of the mold 78. A liquefied composite material, such as a thermosetting urethane is then poured in the trough to the point where the upper surface of the poured composite material 20 is disposed co-planarly with the upper surface 79 of the mold assembly.

The urethane is then allowed to harden or cure sufficiently so that the mold insert can be removed from the trough. The mold insert that emerges from the trough would be similar in shape to the mold insert 10 shown in FIG. 1.

Although the mold assembly 78 is shown in FIG. 3 as essentially a tray that contains a plurality of troughs, it will be appreciated that the mold 78 can be a two-piece mold member having an upper and lower member that defines a cavity into which the liquefied composite is placed. A two piece mold can be employed if a mold insert is desired that includes opposed surfaces that each have features.

Typically, most of the mold inserts 10 that are expected to be created according to the present invention will have at least one planar side, as a planar surface is best for serving as a mold engaging surface. However, it is envisioned that circumstances may arise wherein one would desire to have a mold insert that did not have a planar bottom, but one that rather had surface features.

For example, if one desired to produce a very large mold insert, one might desire to have a portion of the interior of the mold insert comprise a hollow cavity, in order to save both weight and plastic material. In such a case, a pair of mold halves (one male and one female) might be employed that would be joined together to form such a cavity containing mold insert.

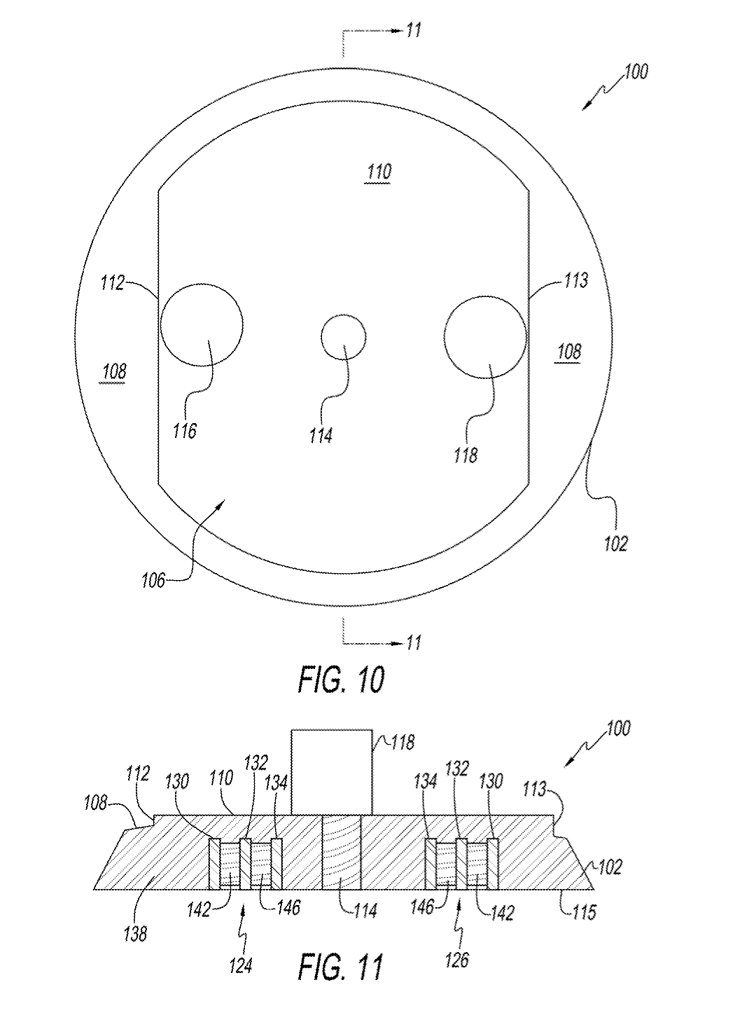

A second (first alternate) body insert 100 is shown in FIGS. 10-12. Mold insert 100 is generally disc-shaped and includes a frustoconical, annular, perimetral surface 102. The mold insert 100 also includes a generally two-leveled planar upper surface 106 having a radially outwardly disposed planar relatively lower portion, and a radially inwardly disposed relatively raised platform portion 110. As shown in FIG. 11, the platform portion 110 is thicker (and higher) than the relatively recessed, radially outwardly disposed planar portion 108. As seen in the top view in FIG. 10, the radially inwardly disposed platform portion 110 is generally circular shaped except that it has a pair of opposed planar “flats” 112, 113.

The mold insert 110 also includes a threaded central aperture 114. The threaded central aperture 114 is employed to make it easier to remove the mold insert 110 from its engagement with the product, such as the concrete structure to which it may be attached after being used to help form a feature in the concrete structure. If the mold insert 100 is too tightly adhered to the concrete structure, one can insert a threaded member, such as a screw, bolt or an eyelet headed bolt into the threaded aperture 114. Once a threaded engagement exists between the threaded bolt and the threaded aperture 114, one can then pull axially on the bolt to extricate the mold insert 100 from its engagement with the concrete form structure. Additionally, the mold insert includes first and second upstanding post 116, 118 that extend in an axial direction out of the upper surface 106 of the mold insert 100. The first and second posts 114, 116 will normally be used to form blind aperture type features in the concrete structure being molded into which the mold insert 100 is placed.

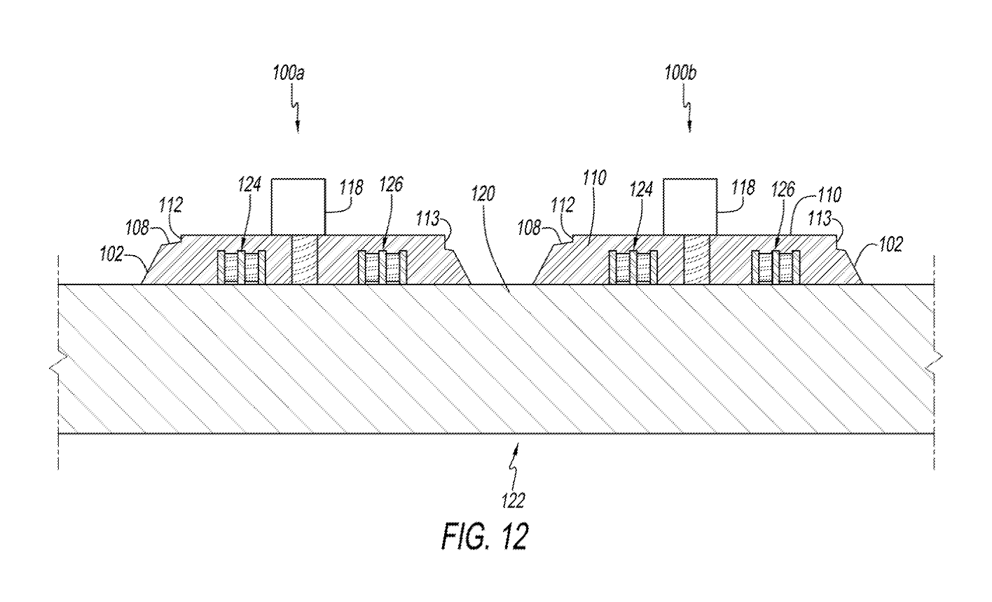

The mold insert 100 also includes a bottom surface 115. As the bottom surface 115 is the mold engaging surface of the mold insert 100, it is preferably planar so as to adhere closely and snugly to the inwardly facing surface 120 of the mold 122 (FIG. 12) to which the mold inserts are attached.

FIG. 12 shows a pair of mold inserts 100a, 100b that are identical o the mold insert 100 shown in FIGS. 10 and 11 as being attached to a surface 120 of a mold 122 of the type used to form a product, such as a concrete structure, and in particular, a pre-cast concrete structure.

The mold insert 100 includes a first stiffener/magnet assembly 124 and a second stiffener/magnet assembly 126. The first and second stiffener/magnet assemblies 124, 126 are disposed in a generally parallel relationship.

Each of the stiffener/magnet assemblies 124, 126 is disposed on an opposite side of the central aperture 124. The first and second stiffener/magnet assemblies 124, 126 each include a first stiffener member 130, a second stiffener member 132, and a third stiffener member 134. Each of the first stiffener member 130, second stiffener member 132 and third stiffener member 134 generally have a configuration similar to stiffener members 54, 56 that are discussed above. Typically, they are ribbon shaped as they have a length dimension that is much greater than the width dimension. Additionally, the stiffener member bars 130, 132, 134 are generally plate like in configuration, that have an upper surface, a lower surface and a series of perforations that pass between the upper surface and the lower surface, so that composite material can fill the perforations to help interlock the first and second stiffener/magnet assemblies 124, 126 to the composite material of the body 138.

The first and second stiffener members 130, 132 are disposed in a spaced, co-planar relationship with each other. The “space” between the first and second stiffener members 132 is filled with a plurality of first and second magnets 142 (not shown) that are similar to the first and second magnets 12, 14 that is shown in connection with the mold insert 10 of FIG. 1.

Similarly, the second 132 and third 134 stiffener members are disposed in a spaced, co-planar relationship so as to form a space there between into which a third and fourth magnet assembly 146 (not shown) are disposed. The third and fourth magnets 146 (not shown) are similar to first and second magnets 142 (not shown), that are also similar to first and second magnets 12, 14 as they are generally plate like rare earth magnets, that are disposed in a linear array along the length of the various stiffener members 130, 132, 134. Adjacent magnets are disposed in opposite orientations, such that the first magnet 142 is disposed in a North-South pole orientation, with the second magnet (not shown) being disposed in a South-North pole orientation.

This North-South and South-North alternating orientation arrangement is repeated for the various magnets along the length of the stiffener/magnet assemblies 124, 126. Through this arrangement, a strong magnetic circuit is achieved that helps to magnetically attach the mold inserts 100a, 10b to the mold engaging surface 120 of the mold 122 that is being used to form the finished product.

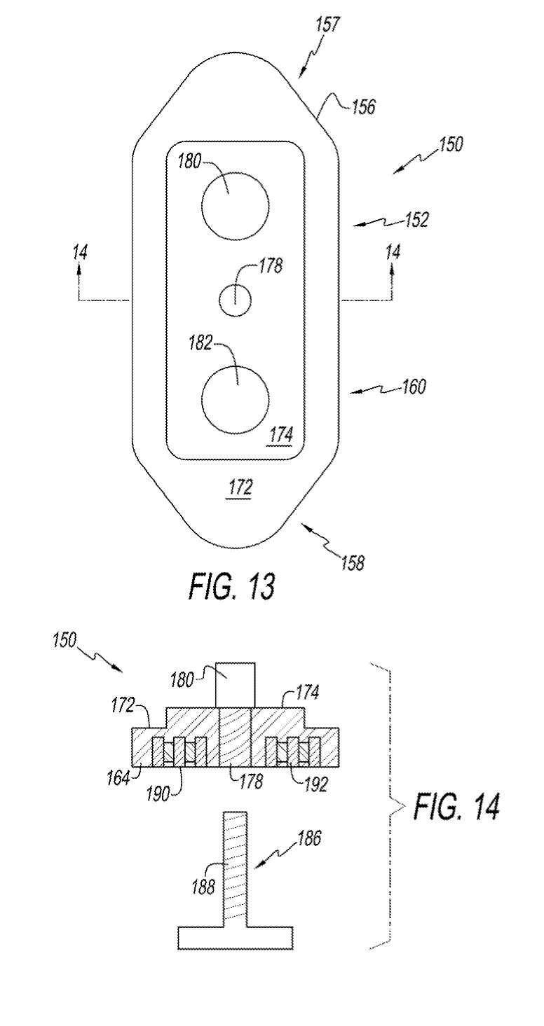

The third embodiment insert 150 is shown in FIGS. 13-15 as including a body portion 152 that is preferably made from a composite material such as urethane or rubber. Preferably, the urethane or rubber is a relatively rigid compound and has a hardness of somewhere close to or near 90 shore A.

The body portion 152 of the third mold insert 150 includes a frustoconical perimetral surface 156 that is designed to be frustoconical to promote easy release of the mold insert 150 both from the mold in which it is created, and the mold in which it is used to form a product, such as the pre-cast concrete slab staircase, etc.

The particular shape of the third embodiment insert 150 is such that it has a first triangular end portion 157, a second triangular end portion 158 and a rectangular middle portion 160 that is disposed between a first and second triangular end portions 157, 158.

Mold insert 150 further includes a generally planar bottom portion 164 that serves as the mold engaging surface. As with the other mold inserts, the bottom surface 164 is preferably planar to help to enhance the adhesion between the mold insert 150 and the steel mold to which it is attached. The upper surface 168 is also planar, and includes a relatively lower radially outwardly disposed portion 172, and a relatively raised round cornered rectangular central portion 174. A central threaded aperture 178 extends through the body portion 156. First and second spaced upstanding posts 180, 182 extend outwardly from the radially inwardly disposed upper surface 174 of the body portion 156. The posts 180, 182 can be any size or configuration, but generally serve a purpose similar to the upstanding post 118 shown in FIG. 12.

A bolt puller 186 is shown in FIG. 14 that includes a threaded shaft 188 that can threadedly engage the threaded inner surface 178 of the threaded aperture. Through the threaded engagement of shaft 188 and threaded aperture 177, the bolt puller 186 can be grabbed by its head and pulled axially to help dislodge the mold insert 150 from a molded product, such as a cast concrete structure to which it is attached.

The mold insert 150 includes a first and second stiffener magnet assembly 190, 192 that are virtually identical in configuration (although possibly different in dimension) than the first and second stiffener magnet assemblies 124, 126 of the embodiment shown in FIG. 11.

Each of the first and second stiffener/magnet assemblies 190, 192 include first, second and third stiffener members, 196, 198, 200 that are disposed in a co-planar relationship with each other, and that are spaced apart from each other to define a first space between the first and second stiffener members 196, 198 and a second space between the second and third stiffener members 198, 200. All of the stiffener members 196, 198, 200 are preferably ribbon like and elongated so that they have a length dimension that is greater than a width dimension, and often can be off by a factor of 5 or 10.

First and second magnet members 202, 204 are disposed in a space between the first and second stiffener members; and third and fourth magnet members 206, 208 are disposed in a space between the second and third stiffener members 198, 200. As with the other magnet members discussed herein, the magnet members should be oriented in a North-South (first magnet member 202), South-North (second magnet member 204) orientation. This similar North-South, South-North arrangement should also be employed for the third and fourth magnet assemblies 206, 208.

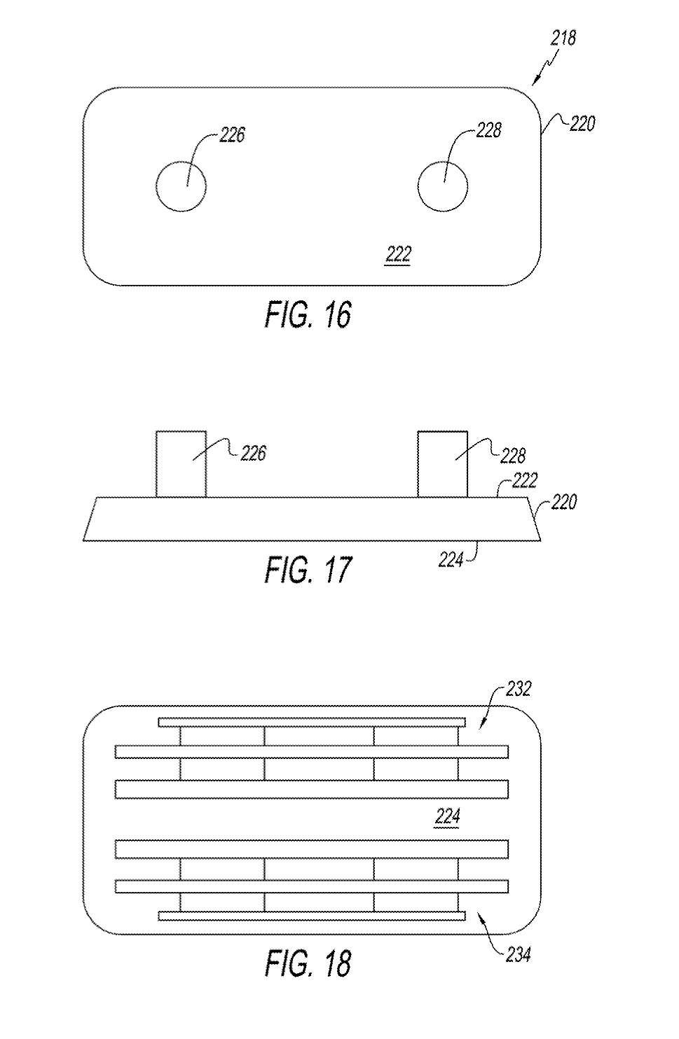

A fourth embodiment mold insert 218 is shown in FIGS. 16-18. The fourth mold insert 218 has a significant number of similarities with second and third mold inserts 100, 150. The primary differences are the fourth mold insert 218 has a different size and shape than the other two mold inserts 100, 150. Additionally, the fourth mold insert 218 lacks a central aperture (that could be added if desired), and also lacks the two-level platform of the mold inserts 100. 150 shown above.

The fourth embodiment mold insert 218 includes a frustoconical, perimetral surface 220, a one-level, planar top surface 222 and a planar bottom mold engaging surface 224. First and second upstanding posts 226, 228 rise upwardly from the planar top surface 222, and are employed to form blind cavities as features in the product, such as the concrete structure with which the mold insert 218 was employed.

A first and second stiffener/magnet assembly 232, 234 are disposed in the body portion 236 of the fourth mold insert 218, and are positioned close to the bottom surface 224 of the fourth mold insert 218, to place the magnets of the stiffener/magnet assemblies 232, 234 in close proximity to the steel mold surface to which the mold insert 218 is being attached.

The first and second stiffener members 232, 234 are constructed generally similarly to the mold stiffener members 124, 126 shown in connection with the mold insert of FIG. 11 and the first and second stiffener/magnet assemblies 190, 192 shown in connection with the third mold insert embodiment 150 shown in FIGS. 14.

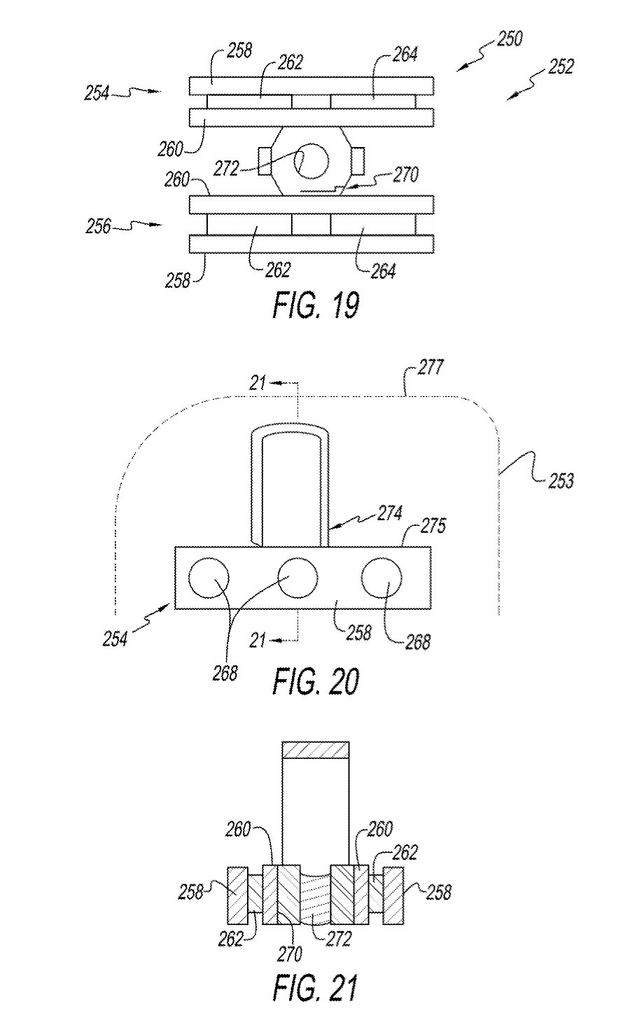

Frame assembly 250 of a fifth mold insert embodiment 252 is shown in FIGS. 19-21. The frame assembly 250 comprises a skeleton of a mold insert 252 whose body portion 253 can take a variety of shapes. In FIG. 20, a potential body shape 253 is shown.

The frame assembly 250 of mold insert 252 is especially well designed for deeper mold inserts, that have a significant depth. As will be appreciated, the frame 250 can be varied significantly in size, length and shape. Additionally, one more frames 250 may be used at any particular mold insert, depending upon the size of the frame 250 that one constructs, and the size of the body portion 253 of the mold insert 252.

The mold insert 252 is formed similarly to the other mold inserts, insofar as a liquid composite material, such as a thermosetting plastic such as polyurethane, or an elastomeric rubber material is poured around the frame, so that the rubber or other composite material forms a body of an appropriate size and shape, and also passes through the various perforations 268 to help secure and interlock the frame 250 to the body portion 253. Additionally, the composite material will extend through the interior of the anchoring loop 274. Anchoring loop 274 serves as a further anchor to interlock the composite material of the body portion 253 with the frame 250.

The frame member 250 includes first and second stiffener/magnet assemblies 254, 256, each of which include a first stiffener bar member 258 and a second stiffener bar member 260 that are disposed in parallel planes in a spaced relation. A first and second magnet member 262, 264 are disposed in a space between the first and second stiffener bar members 258, 260 and are coupled to each of the first and second stiffener bar members 258, 260.

As with the other stiffener bar members discussed herein, the stiffener bar members 258, 260 include a series of perforation, through which composite material can flow for interlocking the composite material to the frame 250.

A central nut shaped anchor 272 is fixedly coupled, such as by welding or soldering to the first and second 254, 256 stiffener/magnet assemblies. The nut shaped anchor 272 includes a threaded central aperture 272 for receiving a threaded shaft of a bolt puller, that enables the user to better dislodge the mold insert 252 front the form or structure that is used to mold.

A bent steel plate like loop 274 extends upwardly, in a loop above the first and second stiffener magnet assemblies 254, 256. The loop 274 provides a further interlock between the composite material of the body 253 and the frame assembly 250. As shown in FIG. 20, the body portion 253 that is likely to be used with frame assembly 250 is a deep section body member 253 of the type that one might use in order to create a deep cavity or recess in the final formed product.

Because of the distance between the top surface 275 of the stiffener member and the top surface 277 of the body 253, a large amount of unreinforced composite would normally exist between the upper surface and the stiffener member 275 and the upper surface of the body portion 277. This large amount of unreinforced composite would have a tendency to sheer away from the frame 250, if the body portion became adhered to the concrete or other material of the molded product with which the mold insert 252 is used. By providing a loop 274, additional anchoring in this upper section of the body portion composite is provided to thereby increase the chances that pulling the frame out of its connection with the molded product will result in the entire body portion being removed from the cavity in a manner wherein the body portion and old insert will remain intact.

Having described the invention with reference to certain preferred embodiments, it will be appreciated that variations and modifications exist within the scope and spirit of the invention as claimed herein.

What is claimed is:

1. A composite member for use with a mold for creating a feature in a product formed in the mold comprising
a bend resistant first stiffener member
at least a first and a second magnet member configured for forming a magnetic current for magnetically coupling the composite member to the mold,
and a composite body portion configured for substantially encasing the stiffener member and the first and second magnet member, the composite body portion including a product engaging surface configured and positioned for defining a surface of the product formed in the mold.

2. A composite member of claim 1 wherein the mold comprises a concrete form, and the product formed in the mold comprises a concrete structure.

3. The composite member of claim 1 wherein the stiffener member comprises a metal plate having a series of apertures that extend through the metal plate.

4. The composite member of claim 3 wherein the metal plate comprises an elongated ribbon shaped metal plate having a length dimension and a width dimension wherein the length dimension is at least five times as great as the width dimension, and wherein the composite body portion extends through the aperture for interlocking the stiffener member to the body portion.

5. The composite member of claim 4 wherein the stick shaped metal plate includes a first planar surface and a second planar surface disposed in a parallel plane with the first planar surface.

6. The composite member of claim 5 wherein the length dimension of the ribbon shaped metal plate is at least ten times the width dimension.

7. The composite member of claim 3 where the metal plate is elongated and ribbon shaped and includes a first planar surface and a second planar surface disposed in a parallel plan with the first planar surface.

8. The composite member of claim 1 where the stiffener member includes a first stiffener member and a second stiffener member disposed in a parallel plane with the first stiffener member.

9. The composite member of claim 8 wherein the first and second stiffener members are disposed in a spaced relation and the first and second magnets are disposed between the first and second stiffener members.

10. The composite member of claim 9 wherein each of the first and second magnet members are coupled to both the first and second stiffener members.

11. The composite member of claim 10 wherein the first and second magnet members are disposed in a linear array in a space between the first and second stiffener members and wherein the first magnet member is disposed in a north-south pole orientation, and the second magnet is disposed in a south-north pole orientation.

12. The composite member of claim 11 further comprising a third stiffener member disposed in a parallel plane with the first and second stiffener members and in a spaced relation with the first and second stiffener members.

13. The composite member of claim 12 further comprising a third and fourth magnet member disposed between and coupled to each of the second and third stiffener members.

14. The composite member of claim 12 wherein each of the first, second and third stiffener members comprise metal plates that include a series of apertures, and wherein the composite of the composite body portion extends through the series of apertures to interlock the first, second and third stiffener members and the composite body portion, and wherein the third magnet member has poles positioned in a north-south orientation and the fourth magnet member has poles positioned in a south-north orientation.

15. The composite member of claim 1 wherein the first and second magnet members are disposed in a linear array along the first stiffener member, with the first magnet members being disposed in a north pole-south pole orientation and the second magnet member being disposed in a south pole-north pole orientation.

16. The composite member of claim 1 further comprising a second stiffener member disposed in a parallel plane within a spaced relation to the first stiffener member, wherein the first and second magnet members are disposed between and coupled to each of the first and second stiffener members.

17. The composite member of claim 16 further comprising a third stiffener member disposed in a parallel plane with and spaced relation to the second stiffener member, and third and fourth magnet members disposed between and coupled to each of the first and second stiffener members.

18. The composite member of claim 17 wherein each of the first, second and third stiffener members include a series of apertures, and wherein the composite of the composite body portion extends through the series of apertures to interlock the first, second and third stiffener members to the body portion, and
wherein the first magnet member has poles positioned in a North-South orientation, the second and magnet member has poles positioned in a South-North orientation.

19. The composite member of claim 1 wherein the body portion of the composite member includes a mold engaging surface configured for being placed against and coupled to a surface of the mold, wherein the first and second magnet members are positioned within the body portion closer to mold engaging surface than the product engaging surface.
